(19) United States
(12) Patent Application Publication
(10) Pub. No.: US 2026/0364516 A1
(43) Pub. Date: Nov. 19, 2026

(54) GAS SEPARATION CONTACTOR MODULE ASSEMBLY AND METHOD FOR MAKING GAS SEPARATION CONTACTOR MODULE ASSEMBLY

(71) Applicant: GE Vernova Infrastructure Technology LLC, Greenville, SC (US)

(72) Inventors: Hongyi ZHOU, Niskayuna, NY (US); Anil R. DUGGAL, Niskayuna, NY (US); Michael Joseph O'BRIEN, Niskayuna, NY (US); Mark Daniel DOHERTY, Niskayuna, NY (US); David Roger MOORE, Niskayuna, NY (US)

(21) Appl. No.: 19/143,273

(22) PCT Filed: Dec. 30, 2022
(86) PCT No.: PCT/US2022/082658

§ 371 Date: Jun. 25, 2025

(51) Int. Cl. B01D 53/04

(52) U.S. Cl. CPC B01D 53/0446; B01D 2253/204; B01D 2257/504

(57) ABSTRACT

A method of forming a gas separation contactor module assembly can include stacking and connecting multiple contactor modules each formed by providing a sorbent material on a film, heat treating the combined sorbent material and film, forming a first frame, sizing the processed sorbent material and film to correspond to the first frame to form a sized sorbent unit, and forming an exposure module by placing sorbent units on top and bottom of first frame. The method further includes disposing at least one of a two-way pipe and a four-way pipe at corners of the exposure module; wherein the at least one of a two-way pipe and a four-way pipe are configured to carry gas to be processed and/or heating gas to the gas separation contactor module assembly. The exposure modules can be stacked vertically and/or horizontally, as can the contactor module assemblies.

### TECHNICAL FIELD

The disclosure relates generally to a gas separation contactor module. More particularly, the disclosure relates to a direct air capture module and method for making a direct air capture module for adsorptive gas separation and systems incorporating the same.

### BACKGROUND

Adsorptive gas separation processes and systems, for example, temperature swing adsorption and partial pressure swing adsorption processes and separators, are known in the art for use in adsorptive gas separation of industrial processes. Pressure swing adsorption (PSA) is a technique used to separate some gas species from a mixture of gases (typically air) under pressure according to the species' molecular characteristics and affinity to an adsorbent material. PSA operates at near-ambient temperature and significantly differs from the cryogenic distillation commonly used to separate gases. Selective adsorbent materials (e.g., zeolites, (aka molecular sieves), activated carbon, etc.) are used as trapping material, preferentially adsorbing the target gas species at high pressure. The process then swings to low pressure to desorb the adsorbed gas.

Temperature-vacuum swing (TVS) cyclic process is used to separate some gas species from a mixture of gases (typically air). TVS can be applied to an amine-functionalized nanofibrilated cellulose sorbent to concurrently extract CO₂ and water vapor from fluids. The promoting effect of the relative humidity on the CO₂ capture capacity and on the amount of co-adsorbed water is quantified.

A conventional temperature swing adsorptive gas separation process may typically employ two fundamental steps, an adsorption step and a regeneration or desorption step. During a typical adsorption step, a feed stream such as a multi-component gas mixture may be admitted into an adsorptive separator and contactor comprising an adsorbent material, where the adsorbent material may adsorb a component of the feed stream, separating the adsorbed component from the remaining components of the feed stream. During a typical subsequent regeneration step, a regeneration or desorption fluid stream, for example, a heated air or steam stream, may be admitted into the adsorptive separator and contactor to increase the temperature of the adsorbent material, causing at least a portion of the adsorbed components to release or desorb from the adsorbent material to provide a desorbed component, and allow for cyclic reuse of the adsorbent material. Conventional adsorptive gas separators typically employ a single composition of one or more adsorbent materials throughout, such as in a conventional bed of beaded adsorbents, or an adsorbent contactor.

One type of industrial process where gas separation may be desirable includes combustion processes, for example, where an oxidant and a carbon-containing fuel are combusted generating at least heat and a combustion gas stream (also known as a combustion flue gas stream). The separation of at least one component from the combustion gas stream may be desirable, including, for example, post-combustion exhaust gas treatment systems.

Over the past decade, sorbents have been used as one class of porous materials for applications in separations, air purification, catalysis, and sensing. Metal-organic frameworks (MOFs) have become one class of sorbents for applications in separations, air purification, catalysis, and sensing. The ability to tune functionality and pore structure of MOFs allows for unprecedented control at nanoscale levels, which has translated to new properties at macroscale levels. The development of MOF-based technologies not only depends on scaling-related issues, but also the ability to incorporate these highly active assemblies into industry-relevant engineered constructs, such as but not limited to, granules and membranes. Active fillers for applications in filtration and separations may include zeolites, metal oxides, and carbons.

### BRIEF DESCRIPTION

All aspects, examples and features mentioned below can be combined in any technically possible way.

An aspect of the disclosure provides a method of forming a gas separation contactor module assembly, the method comprising disposing a sorbent material on a film; heat treating the sorbent material on the film ; sizing the sorbent material on the film to correspond to a size of a first frame to form a sorbent unit; disposing the sorbent unit on the first frame to form a first exposure module; forming second, third, and fourth exposure modules; and attaching at least one of a two-way pipe and a four-way pipe to corners of the first, second, third, and fourth exposure modules with vertical separation therebetween, the first exposure module being a top exposure module and the fourth exposure module being a bottom exposure module, wherein the at least one of a two-way pipe and a four-way pipe are disposed at corners of the gas separation contactor module assembly.

Another aspect of the disclosure includes any of the preceding aspects, and further including stacking the gas separation contactor module assembly so that it is connected with at least one other gas separation contactor module assembly to form a connected gas separation contactor module assembly.

Another aspect of the disclosure includes any of the preceding aspects, and the gas separation contactor module assemblies are connected at their corresponding corners.

Another aspect of the disclosure includes any of the preceding aspects, and the gas separation contactor module assemblies share the at least one of a two-way pipe and a four-way pipe disposed at corners of the exposure modules.

Another aspect of the disclosure includes any of the preceding aspects, and the stacking includes vertically connecting at least two of the gas separation contactor module assemblies and omitting one of the top exposure module of a lower of the gas separation contactor module assemblies and the bottom exposure module of a higher of the gas separation contactor module assemblies.

Another aspect of the disclosure includes any of the preceding aspects, and the stacking includes horizontally connecting at least two of the connected gas separation contactor module assemblies.

Another aspect of the disclosure includes any of the preceding aspects, and at least one of the at least one of a two-way pipe and a four-way pipe is configured to carry at least one of a gas to be processed and a heating gas to the gas separation contactor module assembly.

Another aspect of the disclosure includes any of the preceding aspects, and at least one of the at least one of a two-way pipe and a four-way pipe is configured to alternately carry and deliver to the sorbent material layers the gas to be processed and the heating gas.

Another aspect of the disclosure provides a gas separation contactor module assembly comprising a first sorbent unit and a second sorbent unit, each sorbent unit including a sorbent material disposed on a film; at least three exposure modules each including a first frame having a periphery corresponding to a periphery of each of the first and second sized sorbent units and on which the first and second sorbent units are disposed with respective layers of film facing each other; and at least one of a two-way pipe and a four-way pipe disposed at corresponding corners of the at least three exposure modules with the at least three exposure modules vertically spaced apart, wherein the at least one of a two-way pipe and a four-way pipe are disposed at corners of the gas separation contactor module assembly.

Another aspect of the disclosure includes any of the preceding aspects, and at least one gas separation contactor module assembly is configured to be connected with at least one other gas separation contactor module assembly to form a connected gas separation contactor module assembly.

Another aspect of the disclosure includes any of the preceding aspects, and the gas separation contactor module assemblies are connected at the corners of the gas separation contactor module assemblies.

Another aspect of the disclosure includes any of the preceding aspects, and the gas separation contactor module assemblies share the at least one of a two-way pipe and a four-way pipe disposed at corners of the exposure modules of the gas separation contactor module assemblies.

Another aspect of the disclosure includes any of the preceding aspects, and the connected gas separation contactor module assembly includes at least two vertically connected gas separation contactor module assemblies.

Another aspect of the disclosure includes any of the preceding aspects, and the connected gas separation contactor module assembly includes at least two horizontally connected gas separation contactor module assemblies.

Another aspect of the disclosure includes any of the preceding aspects, and the connected gas separation contactor module assembly further includes at least two vertically connected gas separation contactor module assemblies.

Another aspect of the disclosure includes any of the preceding aspects, and at least one of the at least one of a two-way pipe and a four-way pipe is configured to carry at least one of a gas to be processed and a heating gas.

Another aspect of the disclosure includes any of the preceding aspects, and at least one gas separation contactor module assembly is a direct contactor gas separation contactor module assembly in which at least one of the at least one of a two-way pipe and a four-way pipe is configured to carry at least one of a gas to be processed and a heating gas, and gas to be processed and heating gas alternately flow over the respective sorbent material.

Another aspect of the disclosure includes any of the preceding aspects, and at least one gas separation contactor module assembly is an indirect contactor gas separation contactor module assembly in which only gas to be processed flows over the respective sorbent material.

Another aspect of the disclosure includes any of the preceding aspects, and the first frame includes a top part and a bottom part between which peripheral regions of the film of both the first and second sorbent units are retained.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 illustrates a method for forming a gas separation contactor module, according to embodiments of the disclosure;

FIGS. 2A and 2B illustrate a method for forming a scalable gas separation contactor module sub-assembly, according to embodiments of the disclosure;

FIGS. 3A and 3B illustrate schematic views of another gas separation contactor module, according to embodiments of the disclosure;

FIGS. 4A and 4B illustrate schematic views of another gas separation contactor module, according to embodiments of the disclosure;

FIGS. 5A and 5B are schematic illustrations of a gas separation contactor module assembly, according to embodiments of the disclosure;

FIG. 6 is a schematic illustration of components that form a further embodiment of a gas separation contactor gas separation contactor module, according to embodiments of the disclosure;

FIG. 7 is a schematic front view illustration of a prior art direct contact gas separation contactor module assembly;

FIG. 8 is a schematic front view illustration of an indirect contact gas separation contactor module assembly, according to embodiments of the disclosure;

FIG. 9 is a schematic front view illustration of a pipe integrated direct contact gas separation contactor module assembly, according to embodiments of the disclosure;

FIG. 10 is a schematic front view illustration of a pipe integrated indirect contact gas separation contactor module assembly, according to embodiments of the disclosure;

FIG. 11 illustrates an elevated front view of a gas separation contactor module assembly, according to embodiments of the disclosure;

FIG. 12 illustrates a schematic elevated front view of an implementation of multiple connected gas separation contactor module assemblies, according to embodiments of the disclosure;

FIG. 13 illustrates an elevated front view of an implementation of a direct contact gas separation contactor module assembly, according to embodiments of the disclosure;

FIG. 14 illustrates an elevated side view of a direct contact gas separation contactor module assembly, according to embodiments of the disclosure;

FIG. 15 illustrates an elevated front view of an implementation of multiple connected indirect contact gas separation modules, according to embodiments of the disclosure;

FIG. 16 illustrates an elevated front view of an implementation of multiple connected direct contact gas separation module assemblies, according to embodiments of the disclosure; and

FIG. 17 illustrates an elevated front view of an implementation of multiple connected indirect contact gas separation modules, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant components of a gas separation contactor module, assemblies thereof and processes for making a gas separation contactor module and assemblies thereof, as embodied by the disclosure. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid. The term “downstream” corresponds to the direction of flow of the fluid, and the term “upstream” refers to the direction opposite to the flow (i.e., the direction from which the flow originates). The terms “forward” and “aft,” without any further specificity, refer to directions, with “forward” or “fore” referring to the front, and “aftward” or “aft” referring to the rear.

In addition, several descriptive terms may be used regularly herein, as described below. The terms “first,” “second,” and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present, and that the description includes instances where the event occurs or the component is present and instances where the event does not occur or the component is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Metal-organic frameworks (MOFs) are organic-inorganic hybrid crystalline porous materials that include a regular array of positively charged metal ions surrounded by organic “linker” molecules. The metal ions form nodes that bind “arms” of the linker molecules together, thus forming a repeating, cage-like structure. This cage-like structure forms or includes voids, which causes MOFs to have extraordinarily large internal surface areas. Synthesized MOFs may include internal surface areas of more than 7800 square meters per gram. To put this into context, if you could lay out the available surface area in a teaspoon of this material (around a gram of solid), it would cover an entire soccer field.

MOFs offer unique structural diversity in contrast to other porous materials, including at least uniform pore structures; atomic-level structural uniformity; tunable porosity; extensive varieties; good mechanical and thermal stabilities; and flexibility in network topology, geometry, dimension, and chemical functionality. This unique structural diversity allows control of MOF framework topology, porosity, and functionality. MOF's unique structure design and tunability may be attributed to its crystalline porous materials that include both organic and inorganic components in a rigid periodic networked structure.

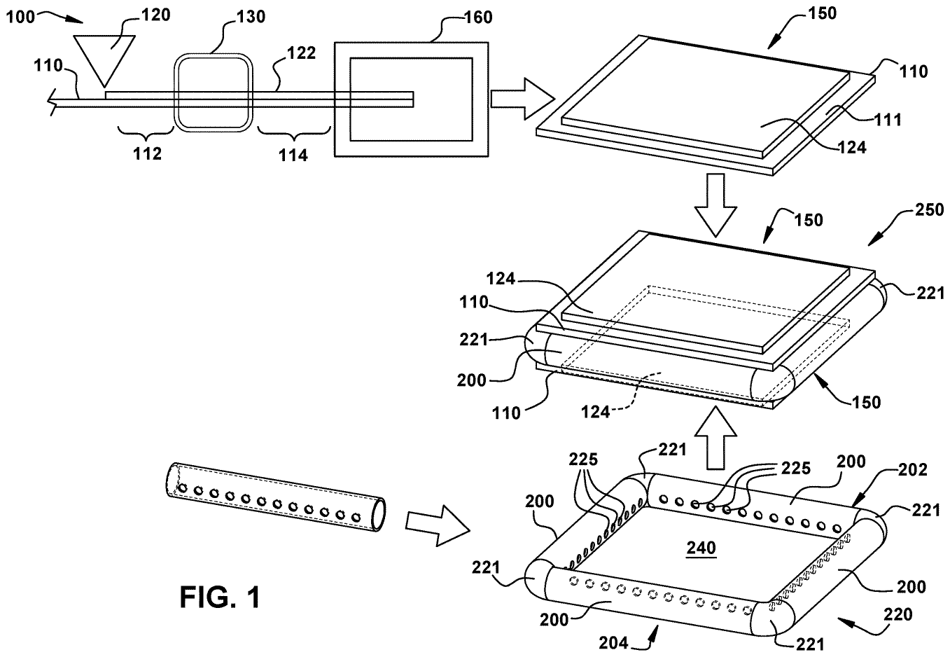

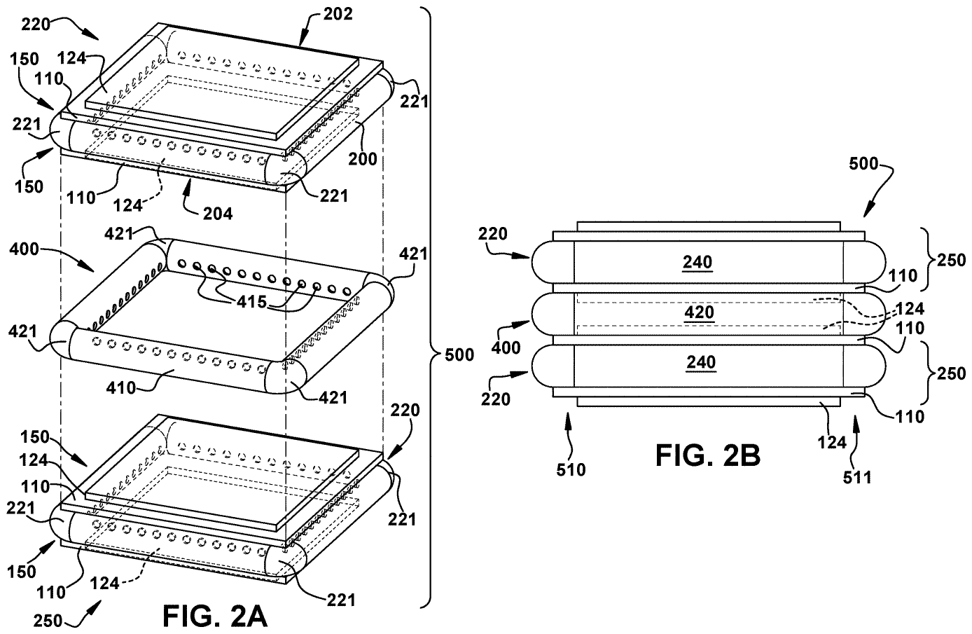

With reference to FIGS. 1 and 2A-2B, the method 100 of forming a contactor module, such as a heating module 250, as embodied by the disclosure will be described. “Contactor module” is used herein as a shortened form of “gas separation contactor module” to reduce wordiness. A film 110 is provided where a source of porous sorbent material 120 including a sorbent material, including, for example, a MOF, additives, and at least one solvent, can be placed on film 110. Film 110 can include any appropriate material. A polymer film is one illustrative film and other films now known or hereinafter developed are within the scope of the embodiments. For example, aspects of the embodiments include film 110 including metallic constituents, fabric constituents, synthetic constituents, man-made constituents, naturally occurring constituents, and combinations thereof.

As noted above, sorbent material 120, as embodied by the disclosure, can be any porous adsorbent material, including MOF materials, such as at least one of iron-based MOFs, zirconium-based MOFs (e.g., MOF-808, such as MOF-808-Gly), aluminum-based MOFs (e.g., MOF-303), zeolitic imidazolate frameworks (ZIFs), amine-containing MOFs, combinations, and other MOFs that are capable of adsorbing fluids and/or other materials from fluids as described herein, including those now known or hereinafter developed. In certain embodiments, sorbent material 120 may include polymeric resins, silicas, zeolites, amines, or combinations thereof, and those now known or hereinafter developed.

Fluids used in embodiments include a gas to be processed that carries a material to be adsorbed, and a heating gas used to regenerate sorbent material 120. Typically, the gas to be processed will be air and the material to be adsorbed will be carbon dioxide, but other gases and materials could be used with corresponding changes to the particular sorbent material 120 used. In addition, the heating gas will typically be steam or hot air, but other heating gases could be used as desired and/or appropriate. For convenience, “air” will be used to describe the gas to be processed, and “steam” will be used to describe the heating gas, but it should be understood that these particular gases are just non-limiting examples and other fluids could be used as desired and/or appropriate. In addition, while “carbon dioxide” is used for convenience to describe the material to be adsorbed, it should be understood that this is a non-limiting example, and other materials can be adsorbed with appropriate changes to the particular sorbent material 120 used in embodiments.

After sorbent material 120 has been disposed on film, film 110 and sorbent material 120 are then progressed to a heat-treating assembly 130. At heat treating assembly 130, sorbent material 120 has any liquid, such as moisture or solvents, it may contain reduced or even eliminated, producing a drier form of sorbent material 120 that contains less liquid than when sorbent material 120 is initially disposed on film 110. Furthermore, at heat treating assembly 130, film 110 and sorbent material 120 may be heated to improve adhesion of sorbent material 120 to film 110.

Sorbent material 120 on film 110 then can be divided and formed into a sorbent unit 150. Sorbent unit 150 can be divided at station 160 where a periphery of sorbent unit 150 is made to correspond to a periphery of a unit frame 220, as described herein, such as by cutting film 110. As illustrated in FIG. 1, sorbent unit 150 can include a margin 111 of film 110 that does not include sorbent material 120. As described hereinafter with respect to unit frame 220, margin 111 can permit adhering of unit frame 220 to sorbent unit 150.

A periphery of sorbent unit 150 and a periphery of unit frame 220 can be formed with substantially equivalent configurations. Further, as embodied by the disclosure, the periphery of unit frame 220 and the periphery of sorbent unit 150 can be formed in a polygonal configuration. Moreover, in a further aspect of the disclosure, the periphery of unit frame 220 and the periphery of sorbent unit 150 can be formed in a rectangular configuration.

Method 100 further includes forming unit frame 220 for fluid flow as described hereinafter. Unit frame 220 includes perforated pipe 200. Perforated pipe 200 sections can be connected to form unit frame 220 with corner pieces 221 connecting perforated pipe 200 sections. Thus, unit frame 220 includes a periphery that corresponds to sorbent unit 150. Corner pieces 221 are pipes that carry fluid, either air or steam, to perforated pipe 200 for moving that fluid in unit frame 220 and through perforations 225 into a chamber 240 to be defined by unit frame 220 and two sorbent units 150, as described hereinafter. As embodied by the disclosure, unit frame 220 can be formed polygonal in configuration. Moreover, as embodied by the disclosure, the periphery of unit frame 220 can be formed rectangular in configuration to align with the periphery of sorbent unit 150. Perforated pipe 200 for unit frame 220 can include plastic perforated pipe 200, polymeric perforated pipe 200, metal perforated pipe 200, composite perforated pipe 200, and other materials now known or hereinafter developed. Perforations 225 in pipe 200 and unit frame 220 allow fluid to flow into and out of pipes 200 and unit frame 220, as described herein. While perforated pipe is used in this example, it should be noted that unperforated pipe or even solid members could be used as long as the gas to be processed and/or the heating gas can be delivered as needed in embodiments.

Next method 100 disposes and aligns unit frame 220 with sorbent unit 150. As embodied by the disclosure, unit frame 220 may be disposed on and in margin 111 of sorbent unit 150.

Thus, in accordance with this aspect of the disclosure, unit frame 220 may be adhered to sorbent unit 150 at margin 111 in a permanent fashion or a removable fashion. Unit frame 220 may be adhered to sorbent unit 150 at margin 111 by any appropriate adherence methodology, including adhesive, heat bonding, welding, mechanical connections, removable fasteners, or any other fastener now known or hereinafter developed.

Unit frame 220 includes a top side 202 and a bottom side 204 (FIG. 1). Method 100, as embodied by the disclosure, further includes forming contactor module 250 (FIG. 1). Forming contactor module 250 includes attaching a sized sorbent unit 150 to top side 202 of unit frame 220 and attaching another sized sorbent 150 to bottom side 204 of unit frame 220, wherein one sorbent unit 150 is disposed on each of both sides 202, 204, with layers of film 110 contacting unit frame 110 and defining chamber 240 therewith. By disposing sorbent material layers 124 as outermost layers as illustrated, contactor module 250 can function as a heating module through which steam or another hot gas can be passed via unit frame 220 to heat sorbent material layers 124, releasing adsorbed carbon dioxide, and by so doing “regenerating” sorbent material 120 in sorbent material layers 124. Thus, contactor module 250, in accordance with aspects of the disclosure, includes layers of a first sorbent unit 150 attached to top side 202 of unit frame 220, and a second sorbent unit 150 attached to the bottom side 204 of unit frame 220, whereby unit frame 220 and two sorbent units 150 form contactor module 250 with a frame chamber 240 therebetween. It should be understood that by instead disposing sorbent material layers 124 facing each other in chamber 240, contactor module 250 can be used as an exposure module through which carbon dioxide laden gas can be passed for adsorption of carbon dioxide by sorbent material layers 124. When sorbent material layers 124 become “full” or saturated, they can be heated to release adsorbed carbon dioxide as desired, regenerating sorbent material 120 in sorbent material layers 124 for further adsorption of carbon dioxide.

Method 100 further includes forming a scalable gas separation contactor module assembly 500 (FIGS. 2A, 2B). As indicated above, for simplicity, gas separation contactor module assembly will be referred to herein as “contactor module assembly.” Scalable contactor module assembly 500 includes multiple contactor modules 250, here configured as heating modules, and an air frame 400. Air frame 400 includes perforated pipe 410. Perforated pipe 410 sections can be connected to form air frame 400 with a periphery that corresponds to a periphery of heating modules 250. Corner pieces 421 connect perforated pipe 410. Thus, air frame 400 includes corner pieces 421 that carry fluid, either air or steam to perforated pipe 410, for moving that fluid in air frame 400, as described hereinafter. As embodied by the disclosure, in a scalable contactor module assembly, adjacent multiple heating modules 250 and an air frame 400 may share corner pieces 221 and 421 where sides of the scalable contactor module assembly 500 adjoin.

As embodied by the disclosure, air frame 400 can be formed in a polygonal configuration. Moreover, as embodied by the disclosure, periphery of air frame 400 can be formed in a rectangular configuration to align with contactor modules 250. Perforated pipe 410 for air frame 400 can include plastic perforated pipe 410, polymeric perforated pipe 410, metal perforated pipe 410, composite perforated pipe 410, and other materials now known or hereinafter developed. Perforations 415 in pipe 410 and air frame 400 allow fluid to flow into and out of pipes 410 and air frame 400, as described hereinafter. As above, portions of air frame 400 could use other members instead of perforated pipe 410, such as unperforated pipe or even solid members, so long as the gas to be processed and/or the heating gas can be delivered as needed.

Scalable contactor module assembly 500 (FIGS. 2A, 2B) includes air frame 400 disposed between two heating modules 250. Scalable contactor module assembly 500 includes one heating module 250 disposed on either side of air frame 400. When so arranged, heating modules 250 and air frame 400 define an exposure chamber 420 therebetween, with sorbent material layers 124 at a top and a bottom of exposure chamber 420. Scalable contactor module assembly 500 is configured for steam flow in heating modules 250 and flow of carbon dioxide laden gas, such as air, in air frame 400 and through exposure chamber 420. An example of operation can include passing air through air frame 400 and exposure chamber 420 until sorbent material layers 124 are “full” or saturated. Hot gas, such as steam, can then be passed through heating modules 250 to heat sorbent material layers 124 to release stored carbon dioxide. Carbon dioxide adsorption can then resume.

The configuration of FIGS. 2A and 2B illustrates only one aspect of embodiments. Scalable contactor module assembly 500, as embodied by the disclosure, can include multiple stacked scalable contactor module assemblies 500. In this aspect of the disclosure, an additional air frame 400 can be connected to one or both heating modules 250, with a further heating module 250 connected to each added air frame 400, resulting in an arrangement with alternating heating modules 250 and air frames 400. Such an arrangement can be repeated and can include as many heating modules 250 and air frames 400 as may be desired for a given use case. It can be advantageous to have heating modules 250 at ends of such arrangements, and in embodiments, an outermost heating module 250 can have film 110 on its outer side if desired, and can also have its sorbent material layer 124 omitted if desired.

Furthermore, an additional aspect of scalable contactor module assembly 500 of FIGS. 2A and 2B would include placing a second scalable contactor module assembly 500 on a “side” of scalable contactor module assembly 500. With respect to FIG. 2B, an additional scalable contactor module assembly 500 can be connected to either of leftmost side 510 of scalable contactor module assembly 500 or rightmost side 511 of scalable contactor module assembly 500 (as illustrated in FIGS. 2A and 2B), though additional modules assemblies 500 could also be placed on a “closer to observer” side and/or a “farther from observer” side of scalable contactor module assembly 500. In this configuration, added heating modules 250 of added scalable contactor module assembly(ies) 500 align with each other, as does additional air frame(s) 400 of added scalable contactor module assembly(ies) 500 with air frame 400. Thus, a “layer” of scalable contactor module assemblies 500 can be formed left-to-right and toward and away from the observer. This arrangement can be combined with the stacking described above to form a three dimensional structure of scalable contactor module assemblies 500 including as many heating modules 250 and air frames 400 as may be desired and/or appropriate for a particular application.

Accordingly, as embodied by the disclosure, a contactor module 250, such as a heating module, includes a first sorbent unit 150 and a second sorbent unit 150, each sorbent unit 150 including a sorbent material layer 124 disposed on film 110; and unit frame 220, with unit frame 220 including top side 202 and bottom side 204. Unit frame 220 with film 110 forms chamber 240 for flow of a fluid. In accordance with certain aspects of the disclosure, chamber 240 is configured for flow of steam to heat sorbent material layers 124 for release of captured material(s).

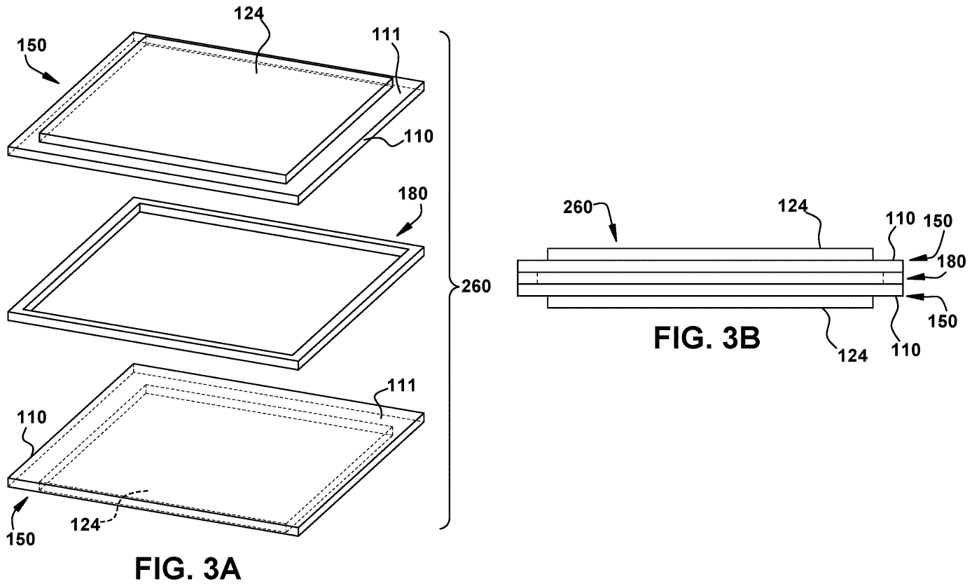

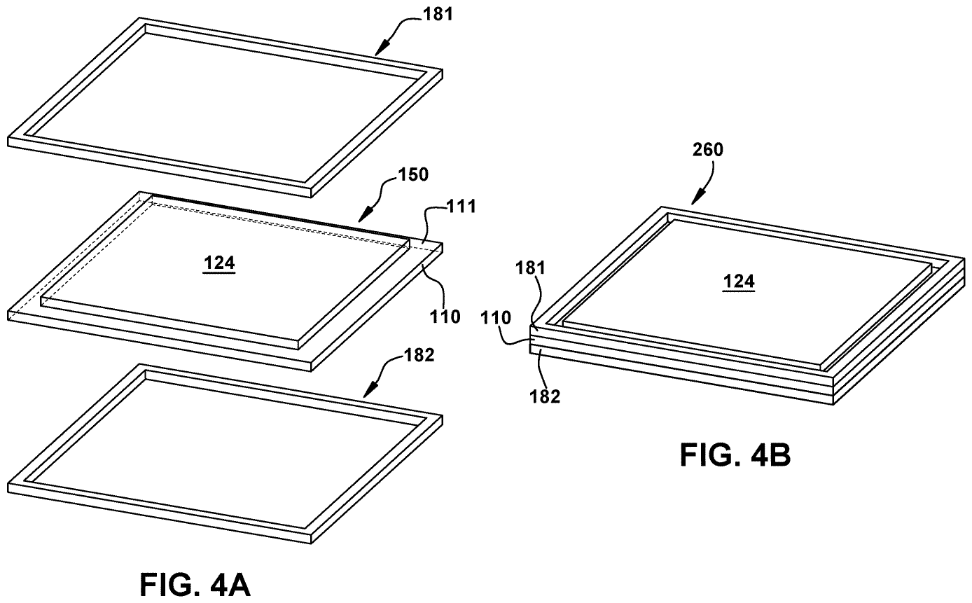

FIGS. 3A and 3B show an alternative form of contactor module of embodiments, here referred to as exposure module 260, in which a sorbent unit 150 can be attached to a solid frame 180. In embodiments, two sorbent units 150 can be attached to solid frame 180 with layers of film 110 facing each other. In either case, film 110 of sorbent units 150 can be attached to solid frame 180 in much the same manner as described above with relation to attachment of sorbent units 150 to unit frame 220 (FIG. 1). Alternatively, as seen in FIGS. 4A and 4B, frame 180 of exposure module 260 can include a top part 181 and a bottom part 182 that can be placed on either side of film 110 of sorbent unit 150 to retain film 110 therebetween. For example, top part 181 and bottom part 182 can include features that interlock when assembled and force is applied, clamping film 110 therebetween. Such a multiple part frame can be used with or without adhesive or other attachment means as may be suitable and/or desired. It should also be noted that two sorbent units 150 could be used with a multiple part frame 180 if desired and/or appropriate. Further, while a four-sided solid frame 180 is shown as an example, some embodiments can instead use two opposed members, including in the example shown in FIGS. 4A and 4B, in which case each of the two opposed members would be a two part member.

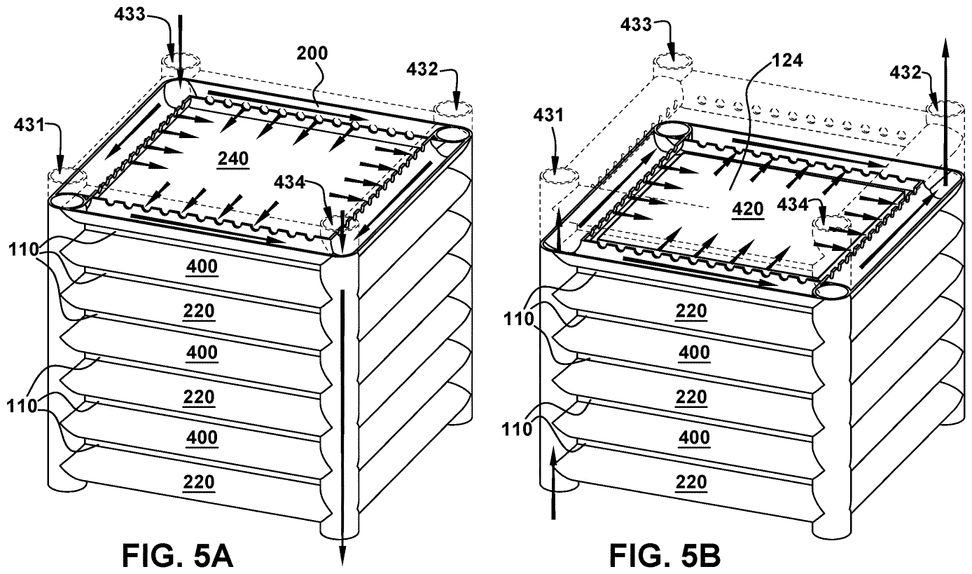

FIGS. 5A and 5B schematically illustrate an example of a configuration of stacked air frames 400, sorbent units 150, and unit frames 220 and flow of fluids therein. In FIGS. 5A and 5B, opposed corners are source and drain of gas for each chamber. Thus, as illustrated in FIG. 5B and particularly with the top air frame 400 shown, carbon dioxide laden gas, such as air, can be supplied on first corner 431 so that flow of gas is in a first direction into each air chamber 420, such as through perforations 415, through chamber 420 to and out opposite second corner 432. Similarly, as illustrated in FIG. 5A and particularly with the top unit frame 220 shown, hot gas, such as steam, can be supplied on third corner 433 so that flow of steam is in a second direction into each chamber 240, such as via perforations 225, passing through chamber 240 to and out of opposite fourth corner 434. In this configuration, the major direction of flow through each chamber is diagonal so that steam and air flow essentially orthogonal to each other. The stacking and layering arrangements described above with regard to the example illustrated in FIGS. 2A and 2B can be applied to the example of FIGS. 5A and 5B to form a structure including as many air frames 400, sorbent units 150, and unit frames 220 as may be suitable and/or desired.

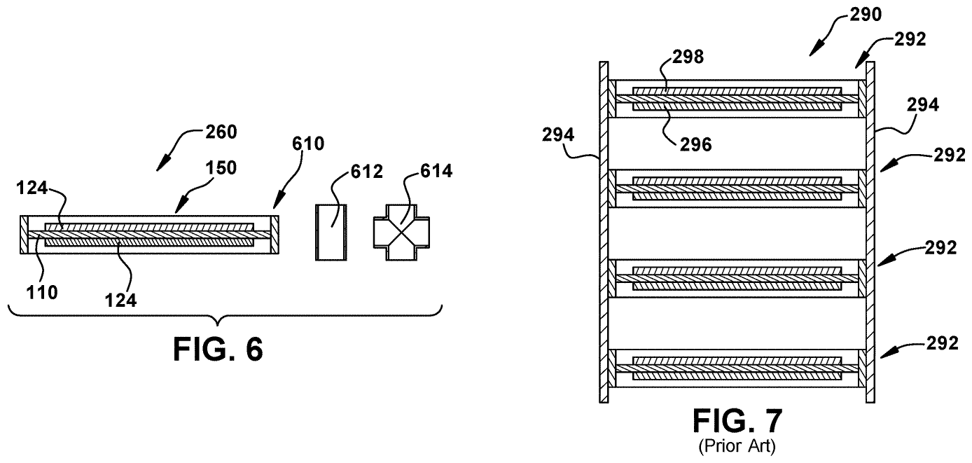

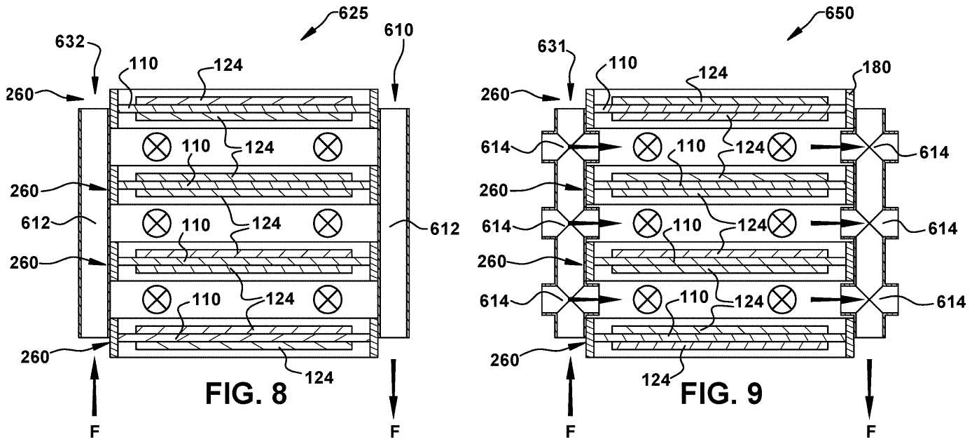

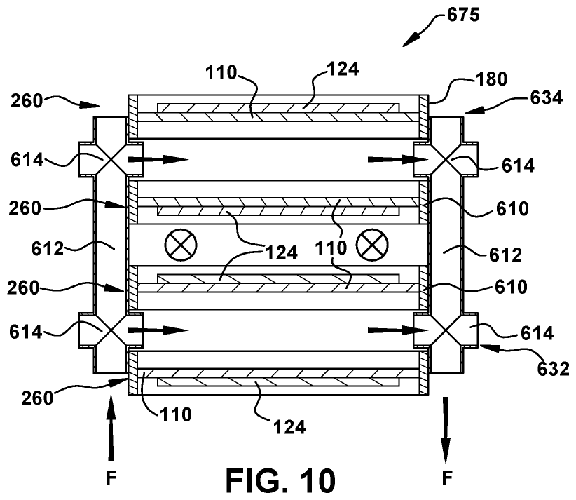

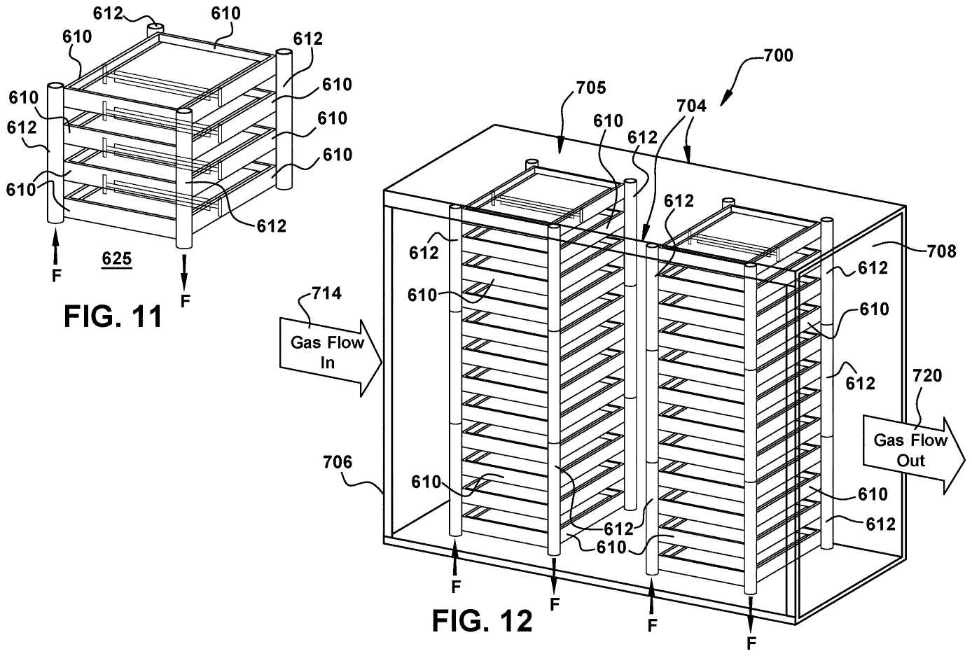

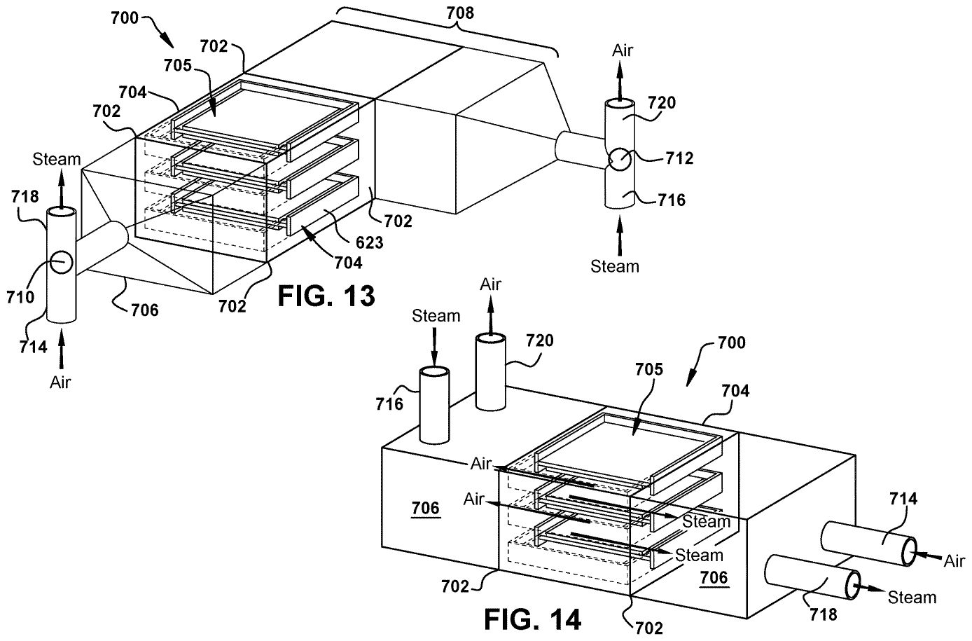

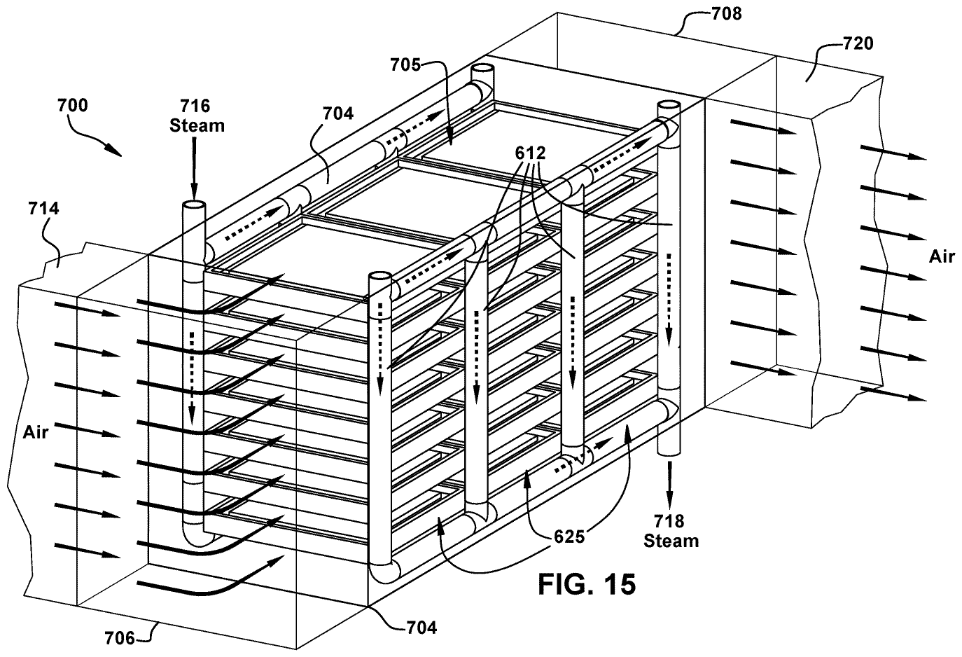

FIGS. 6 and 8-11 illustrate further embodiments of the contactor module assembly configurations, according to aspects of the disclosure. FIG. 6 illustrates components that form constituents of a contactor module, here referred to as an exposure module 260, according to embodiments of the disclosure. FIG. 7 shows a front view of a representative prior art direct contact contactor module assembly 290. FIG. 8 shows a front view of a representative indirect contact pipe heating contactor module assembly 625, as embodied by the disclosure. FIG. 9 is a front view illustration of a pipe-integrated direct contact/heating contactor module assembly 650, according to embodiments of the disclosure. FIG. 10 sets forth a front view of a pipe-integrated indirect contact/heating contactor module assembly 675, according to embodiments of the disclosure. FIG. 11 illustrates an elevated front view of the indirect contact pipe heating contactor module assembly 625 of FIG. 8. FIG. 12 illustrates an elevated side view of a plurality of pipe-integrated indirect heating contactor module assembly 625 arranged and connected in two stacks adjacent each other, according to embodiments of the disclosure. FIGS. 13 and 14 illustrate implementations of direct contact module assembly 625. FIGS. 15-17 illustrate implementations of contact module assemblies 625, 650, 675, according to embodiments of the disclosure.

As embodied by the disclosure, a contactor module assembly includes sorbent material, such as a MOF, that is disposed to have direct contact with a fluid that contains materials to be captured. The sorbent material and fluid “touch” or are interfaced. A direct contact contactor module assembly brings a heat source, such as steam or another hot fluid, into direct contact with the sorbent material to facilitate desorption and regeneration of the sorbent material so that the sorbent material may be reused for further capture. Conversely, an indirect contact contactor module assembly has an intermediary element that separates direct contact of the sorbent material from the heat source, such as steam or another hot fluid. For example, and as illustrative and as embodied by the disclosure, a polymeric material can be disposed between the sorbent material and the carrier of the heat used to facilitate desorption to regenerate the sorbent material for further capture.

With regard to FIG. 6, a sorbent unit 150, is provided, such as mounted on a frame 610, which can be frame 180 as illustrated in FIGS. 3A, 3B, 4A, and 4B, to form exposure module 260. As above, some embodiments can use a frame 180 including at least two opposed members, while others can use a four-sided frame using four members, and each member can be one part or can have two parts. As embodied by the disclosure, sorbent unit 150 can be any appropriate sorbent unit. For ease of discussion, the description of FIGS. 6-10 will reference sorbent unit 150 as described and provided with respect to the above embodiment and as illustrated in FIGS. 1, 3, and 4. Accordingly, reference is made to the above description of sorbent unit 150 for a discussion of the formation and configuration of sorbent unit 150 and exposure module 260.

In FIG. 6, components that form constituents of a contactor module assembly are illustrated. In FIG. 6, frame 610, such as frame 180, for sorbent unit 150 is provided. Frame 610 encircles sorbent unit 150 in embodiments and is attached to film 110. As with the above embodiments, frame 610 and a periphery of sorbent unit 150 can be formed in a polygonal configuration. Moreover, in a further aspect of the disclosure, a periphery of frame 610 and the periphery of sorbent unit 150 can be formed in a rectangular configuration. It should be noted that while two layers of sorbent material 124 are shown, either layer of sorbent material 124 can be omitted, such as for a top or bottom of an exposure module 260 that is at the top of bottom of an assembly. It is advantageous to provide two sorbent material layers 124 by mounting two sorbent units 150 with their film layers 110 engaging each other.

Of note, contactor module 250 (FIG. 1) and exposure module 260 have some differences in operation. For example, contactor module 250 (FIG. 1) defines chamber 240 through which fluid is passed for heating or for processing of gas for adsorption, depending on the particular orientation of sorbent units 150. By contrast, exposure module 260 is configured for passage of fluid over its exterior.

FIG. 7 illustrates a prior art direct contact contactor assembly in which multiple contactor modules 292 are arranged between sidewalls 294 and have a support layer 296 on which sorbent material 298 is present. During operation, gas to be processed is passed through the assembly 290 and over sorbent material 298 of contactor modules 290 into or out of the page until sorbent material 298 is saturated, at which point a heating gas is passed through the assembly 290 out of or into the page to regenerate sorbent material 298. When sorbent material 298 is regenerated, gas to be processed is then passed through the assembly 290 into or out of the page and the cycle repeats as desired.

FIGS. 8-11 illustrate examples of contactor module assemblies 625, 650, 675 that can be constructed using exposure module 260, 2-way pipe(s) 612, and 4-way pipe(s) 614. In the embodiments of FIGS. 8-10, frame 610 does not convey fluids to the sorbent material layers 124. Rather, gas to be processed, carrying material to be adsorbed, is passed through ends of the assembly (not shown) into or out of the page, and heating fluid or heating gas, such as steam and/or hot air, is carried to contactor module assemblies 625, 650, and 675 through one or more of a 2-way pipe 612 and a 4-way pipe 614. Two-way pipe 612 permits flow in two directions, and as illustrated in FIGS. 8-11, the two directions are vertical with respect to the FIGS. Four-way pipe 614 permits flow in four directions. As illustrated in FIGS. 9 and 10, the four directions are vertical and horizontal with respect to the FIGS. In other words, the four flow directions in four-way pipe 614 are orthogonal with respect to each other on x and y axes.

FIGS. 13 and 14 schematically illustrate an implementation of a contactor module assembly 625 in a capture device 700. FIG. 13 illustrates an elevated end view, while FIG. 14 illustrates an elevated side view. Capture device 700 includes a confinement 702 for contactor module assembly 625. Confinement 702 has side walls 704 that engage and/or support frames 610 of contactor module 625, as well as top and bottom walls 705. First and second plenums 706, 708 can be attached at opposite ends of confinement 702, each having one of first and second valves 710, 712 (not shown in FIG. 14) to switch between respective conduits. For example, in a capture cycle, first valve 710 can be open to a first source conduit 714, such as a source of gas to be processed, and second valve 712 can be open to a first drain conduit 720.

With this configuration, gas to be processed can enter first plenum 706, pass through contactor module assembly 625, and exit via second plenum 708. Similarly, during a regeneration cycle, second valve 712 can be open to a second source conduit 716, such as a source of heating gas, and first valve 710 can be open to a second drain conduit. With this configuration, heating gas can enter second plenum 708, pass through contactor module assembly 625, and exit via first plenum 706. The flow directions are particularly illustrated in FIG. 14, where the example gas to be processed is air and the example heating gas is steam.

The embodiments of FIGS. 8-11 further include the ability for forming scalable contactor module assemblies 625, 650, and 675. Scalable contactor module assemblies 625, 650, and 675 include multiple contactor module assemblies 625, 650, and 675 positioned horizontally side by side and/or one on top of another vertically, as design needs necessitate, as illustrated schematically in FIGS. 12 and 15-17. The scalable contactor module assembly 625, 650, and 675 is combinable, either stackable vertically or horizontally, with at least one other contactor module assembly 625, 650, and 675 to form a stacked contactor module assembly 625, 650, and 675.

In certain aspects of the embodiments, as illustrated in FIGS. 15-17, adjacent side by side contactor module assemblies 625, 650, and 675 can share either the two-way pipes 612 of adjacent scalable contactor module assemblies 625, 650, and 675, or share four-way pipes 614 of adjacent scalable contactor module assemblies 625, 650, and 675, wherein the shared pipes, either two-way pipe 612 or four-way pipe 614, are at corners of the adjacent scalable contactor module assemblies 625, 650, and 675. By positioning either two-way pipe 612 or four-way pipe 614 at corners of the adjacent scalable contactor module assemblies 650, and 675, air and/or steam flow, which is designated by arrow F in two-way pipes 612 or four-way pipes 614, can be effectively carried to one or more of the adjacent scalable contactor module assemblies 650, and 675.

Further, in certain aspects of the embodiments, one on top of another vertical contactor module assemblies 625, 650, and 675 can share either the two-way pipe 612 of a bottom or top scalable contactor module assemblies 625, 650, and 675, or share four-way pipes 614 of a bottom or top scalable contactor module assemblies 625, 650, and 675. Moreover, in certain embodiments, with the positioning of either two-way pipe 612 or four-way pipe 614 at corners of the adjacent scalable contactor module assemblies 650, and 675, air and/or steam flow, which is designated by arrow Fin two-way pipes 612 or four-way pipes 614, can be effectively carried to one or more of the vertically oriented and/or stacked scalable contactor module assemblies 650, and 675.

In FIGS. 8-10 showing embodiments of scalable contactor module assemblies 625, 650, and 675, heating gas flow, such as hot air and/or steam flow, is designated by arrow F in two-way pipes 612 or four-way pipes 614. Also, flow in the scalable contactor module assemblies 625, 650, and 675, such as flow of gas to be processed, such as air, is into the page, designated by the end of an arrow as an “x” in a circle, and out of the page, designated by the tip of an arrow as a circle with a dot at its center.

Thus, in FIG. 8, heating gas is conveyed by pipes 612, and gas to be processed is shown as passing into the page. For example, air can be passed between exposure modules 260 and over sorbent material layers 124 so that sorbent material layers 124 can adsorb carbon dioxide. When sorbent material layers 124 become saturated with carbon dioxide, air flow can be stopped, and hot gas, such as steam, can be conveyed through two-way pipes 612 to heat and regenerate sorbent material layers 124. When sorbent material layers 124 are sufficiently regenerated, air flow, can resume and air can be passed over sorbent material layers 124, such as into the page as illustrated in FIG. 8, to capture more carbon dioxide. These steps can be repeated as desired. It will be understood that during regeneration, carbon dioxide is released into air remaining between exposure modules 260, which air can be directed to carbon dioxide storage systems known in the art. In embodiments, air flow can continue during regeneration, with air exiting exposure modules 260 being directed to carbon dioxide storage.

Likewise, in FIG. 9 heating gas is conveyed by pipes 614 and between exposure modules 260 during a regeneration cycle, and gas to be processed is shown as flowing into the page during a capture cycle. In this manner, for example, air can be passed between exposure modules 260 and over sorbent material layers 124 so that sorbent material layers 124 can adsorb carbon dioxide. When sorbent material layers 124 become saturated with carbon dioxide, air flow can be stopped, and steam can be passed between exposure modules 260 via pipes 614 to heat and regenerate sorbent material layers and carry released carbon dioxide out of contactor module assembly 650. When sorbent material layers 124 are sufficiently regenerated, steam flow can be stopped and air flow can resume until saturation of sorbent material layers 124, and this cycle can repeat as desired. It will be understood that during regeneration, carbon dioxide is released into steam flowing between exposure modules 260, which steam can be directed to carbon dioxide storage systems known in the art.

Similarly, in FIG. 10, heating gas passes through pipes 612 and 614 and between the top two and bottom two exposure modules 260 of contactor module assembly 675, and gas to be processed passes into the page between the middle two exposure modules 260. For example, during capture, air can be passed between the middle two exposure modules 260 and over sorbent material layers 124 so that carbon dioxide can be adsorbed by sorbent material layers 124. When sorbent material layers 124 become saturated with carbon dioxide, air flow can be stopped, and steam can be passed between the top two and bottom two exposure modules 260 via pipes 614 to heat and regenerate sorbent material layers 124. When sorbent material layers 124 are sufficiently regenerated, steam flow can be stopped and air flow can resume until saturation of sorbent material layers 124, and these steps can be repeated as desired. It will be understood that during regeneration, carbon dioxide is released into air remaining between the middle two exposure modules 260, which air can be directed to carbon dioxide storage systems known in the art. In embodiments, air flow can continue during regeneration, with air exiting exposure modules 260 being directed to carbon dioxide storage.

Turning now to FIG. 15, an implementation of a capture device 700 includes a containment 702 in which multiple indirect contactor module assemblies 625 are housed. As shown, indirect contactor module assemblies 625 can be stacked and placed side by side and can share pipes 612 at their corners. Containment 700, as in FIGS. 13 and 14, can include side walls 704 and top and bottom walls 705. First plenum 706 and second plenum 708 can be mounted on ends of containment 702, but here, each plenum only handles gas to processed via first source conduit 714 and first drain conduit 720, respectively. Second source conduit 716 can be connected to one or more pipes 612, 614 (FIGS. 6, 8-11), which can convey heating gas among assemblies 625 and to second drain conduit 718. Additional pipes may be added to enhance steam distribution as appropriate or desired. In this configuration, for example, air can be passed through contactor module assemblies 625 for capture of carbon dioxide and steam can be passed through the pipes to heat and regenerate sorbent material in contactor module assemblies 625.

Flow of air can be continuous in embodiments, with air exiting device 700 during regeneration being diverted to storage.

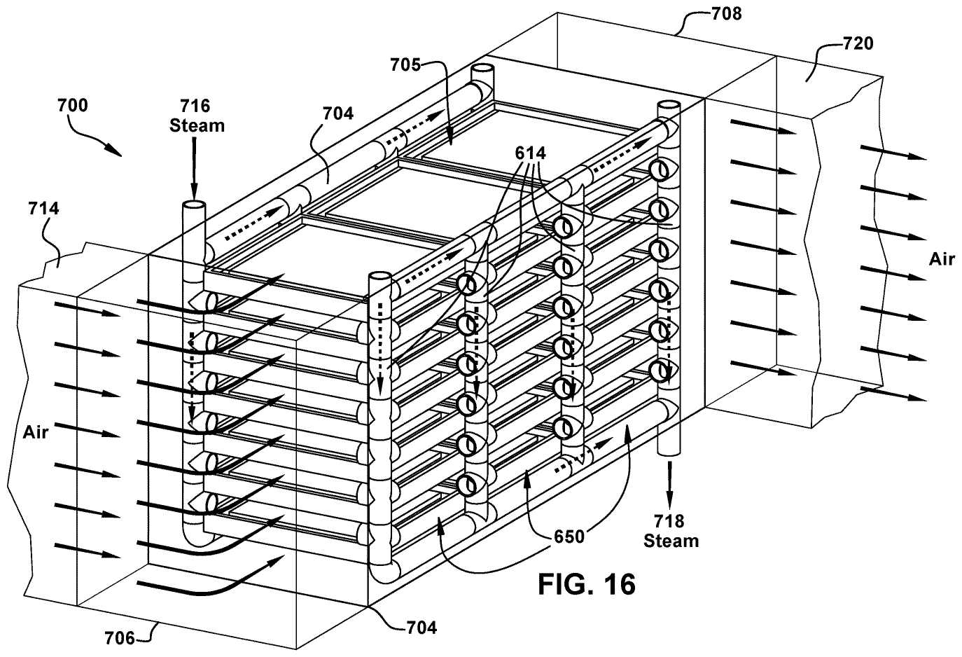

In FIG. 16, capture device 700 uses multiple connected contactor module assemblies 650, which are pipe-integrated direct contact module assemblies. The bulk of the example of FIG. 16 is the same as that shown in FIG. 15, but here 4-way pipes 614 can be used to pass steam directly through contactor module assemblies 650 during regeneration. Here, flow of air must be stopped during regeneration or sufficient heating for regeneration may not be possible.

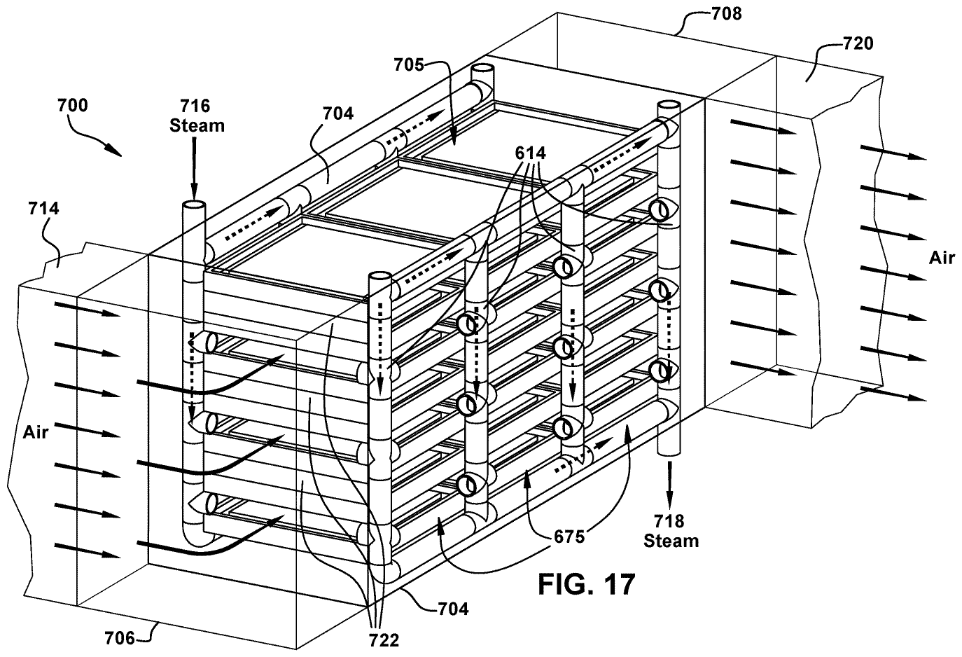

In FIG. 17, capture device uses multiple connected contactor modules assemblies 675, which are pipe-integrated indirect contactor module assemblies. Again, the structure is very similar to that of FIGS. 15 and 16, but here 2-way pipes 612 and 4-way pipes 614 are configured as in FIG. 10, with alternating heating and capture chambers defined between exposure modules of the contactor module assemblies 675. In addition, baffles 722 can be included to prevent air from entering heating exposure modules of contactor module assemblies 675. In the particular illustration, six contactor module assemblies 675 are shown in three adjacent stacks of two and sharing corner pipes. Similar to the illustration of FIGS. 10 and 11, the chambers defined by the top two and bottom two exposure modules and by every other (vertically) pair of exposure modules are heating chambers and 4-way pipes 614 allow steam to pass therethrough during regeneration. Here, air flow could be allowed to continue during regeneration, with air exiting second plenum 708 during regeneration being directed to carbon dioxide storage.

As will be appreciated, a technical effect of embodiments herein is to enable relatively inexpensive, very scalable modular assemblies for capture of gas-borne materials, such as carbon dioxide in air. Lower cost is achieved by using less expensive materials, such as plastic pipe or frames or the like. Scalability is achieved by the modular nature of the assemblies themselves.

While FIGS. 12 and 15-17 show configurations of six assemblies, it should be understood that the stacks can be higher and wider, as can the rows. In other words, with suitable changes to confinement, the connected assemblies of FIGS. 15-17 could themselves be replicated and connected in three axes to achieve enormous capture capacity.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

What is claimed is:

1. A method of forming a gas separation contactor module assembly, the method comprising:
disposing a sorbent material on a film;
heat treating the sorbent material on the film;
sizing the sorbent material on the film to correspond to a size of a first frame to form a sorbent unit;
disposing the sorbent unit on the first frame to form a first exposure module;
forming second, third, and fourth exposure modules; and
attaching at least one of a two-way pipe and a four-way pipe to comers of the first, second, third, and fourth exposure modules with vertical separation therebetween, the first exposure module being a top exposure module and the fourth exposure module being a bottom exposure module, wherein the at least one of a two-way pipe and a four-way pipe are disposed at corners of the gas separation contactor module assembly.

2. The method of claim 1, further including stacking the gas separation contactor module assembly so that it is connected with at least one other gas separation contactor module assembly to form a connected gas separation contactor module assembly.

3. The method of claim 2, wherein the gas separation contactor module assemblies are connected at their corresponding corners.

4. The method of claim 1, wherein the gas separation contactor module assemblies share the at least one of a two-way pipe and a four-way pipe disposed at corners of the exposure modules.

5. The method of claim 4, wherein the stacking includes vertically connecting at least two of the gas separation contactor module assemblies and omitting one of the top exposure module of a lower of the gas separation contactor module assemblies and the bottom exposure module of a higher of the gas separation contactor module assemblies.

6. The method of claim 4, wherein the stacking includes horizontally connecting at least two of the connected gas separation contactor module assemblies.

7. The method of claim 1, wherein at least one of the at least one of a two-way pipe and a four-way pipe is configured to carry at least one of a gas to be processed and a heating gas to the gas separation contactor module assembly.

8. The method of claim 7, wherein the at least one of the at least one of a two-way pipe and a four-way pipe is configured to alternately carry and deliver to the sorbent material layers the gas to be processed and the heating gas.

9. A gas separation contactor module assembly comprising:
a first sorbent unit and a second sorbent unit each sorbent unit including a sorbent material disposed on a film; at least three exposure modules each including a first frame having a periphery corresponding to a periphery of each of the first and second sorbent units and on which the first and second sorbent units are disposed with respective layers of film facing each other; and
at least one of a two-way pipe and a four-way pipe disposed at corresponding corners of the at least three exposure modules with the at least three exposure modules vertically spaced apart, wherein the at least one of a two-way pipe and a four-way pipe are disposed at comers of the gas separation contactor module assembly.

10. The gas separation contactor module assembly of claim 9, wherein at least one gas separation contactor module assembly is configured to be connected with at least one other gas separation contactor module assembly. to form a connected gas separation contactor module assembly

11. The gas separation contactor module assembly of claim 10, wherein the gas separation contactor module assemblies are connected at the comers of the gas separation contactor module assemblies.

12. The gas separation contactor module assembly of claim 9, wherein the gas separation contactor module assemblies share the at least one of a two-way pipe and a four-way pipe disposed at corners of the exposure modules of the gas separation contactor module assemblies.

13. The gas separation contactor module assembly of claim 12, wherein the connected gas separation contactor module assembly includes at least two vertically connected gas separation contactor module assemblies.

14. The gas separation contactor module assembly of claim 12, wherein the connected gas separation contactor module assembly includes at least two horizontally connected gas separation contactor module assemblies.

15. The gas separation contactor module assembly of claim 14, wherein the connected gas separation contactor module assembly further includes at least two vertically connected gas separation contactor module assemblies.

16. The gas separation contactor module assembly of claim 9, wherein at least one of the at least one of a two-way pipe and a four-way pipe is configured to carry at least one of a gas to be processed and a heating gas.

17. The gas separation contactor module assembly of claim 9, wherein at least one gas separation contactor module assembly is a direct contactor gas separation contactor module assembly in which at least one of the at least one of a two-way pipe and a four-way pipe is configured to carry at least one of a gas to be processed and a heating gas, and gas to be processed and heating gas alternately flow over the respective sorbent material.

18. The gas separation contactor module assembly of claim 9, wherein at least one gas separation contactor module assembly is an indirect contactor gas separation contactor module assembly in which only gas to be processed flows over the respective sorbent material.

19. The gas separation contactor module assembly of claim 9, wherein the first frame includes a top part and a bottom part between which peripheral regions of the film of both the first and second sorbent units are retained.

20. The gas separation contactor module assembly of claim 1, wherein the first frame includes a top part and a bottom part between which peripheral regions of the film of both the first and second sorbent units are retained.
